(19) United States
(12) Patent Application Publication
(10) Pub. No.: US 2019/0044107 A1
(43) Pub. Date: Feb. 7, 2019

(54) ENERGY STORAGE DEVICE AND MANUFACTURING METHOD OF THE SAME

(71) Applicant: GS Yuasa International Ltd., Kyoto-shi (JP)

(72) Inventor: Shun ITO, Kyoto-shi, Kyoto (JP)

(73) Assignee: GS Yuasa International Ltd., Kyoto-shi (JP)

(21) Appl. No.: 16/076,628

(22) PCT Filed: Jan. 31, 2017
(86) PCT No.: PCT/JP2017/003436

§ 371 Date: Aug. 8, 2018

(30) Foreign Application Priority Data
Feb. 19, 2016 (JP) 2016-030473

(51) Int. Cl. H01M 2/06; H01G 11/66; H01G 11/74; H01G 11/30; H01G 11/86; H01G 11/28; H01M 2/30; H01M 2/26

(52) U.S. Cl. CPC H01M 2/06; H01G 11/66; H01G 11/74; H01M 2/26; H01G 11/86; H01G 11/28; H01M 2/30; H01G 11/30

(57) ABSTRACT

An energy storage device includes: a terminal portion; a current collector; and a connecting portion which connects the terminal portion and the current collector, wherein the terminal portion includes a cylindrical portion which is bottomed at one end side and is open at an other end side, wherein the connecting portion is inserted into and connected to the cylindrical portion, wherein, on an outer surface of the connecting portion, a concave portion of the connecting portion or a convex portion of the connecting portion is formed, and wherein, on an inner surface of the cylindrical portion, a convex portion on the inner surface of the cylindrical portion or a concave portion on the inner surface of the cylindrical portion, which is engaged with the concave portion of the connecting portion or the convex portion of the connecting portion, is formed.

### TECHNICAL FIELD

The present invention relates to an energy storage device which includes a terminal portion, a current collector, and a connecting portion which connects the terminal portion and the current collector, and a method of manufacturing the energy storage device.

### BACKGROUND ART

Conventionally, there has been known an energy storage device which includes a terminal portion, a current collector, and a connecting portion which connects the terminal portion and the current collector. For example, as described in patent document 1, an energy storage device (battery) includes a terminal portion (upper terminal body), a current collector (current collecting connecting body), and a connecting portion (lower terminal body) which connects the terminal portion and the current collector. The connecting portion is connected to the terminal portion by brazing, press fitting or the like.

### PRIOR ART DOCUMENTS

### Patent Documents

Patent Document 1: JP-A-2001-357834

### SUMMARY OF THE INVENTION

### Problems to be Solved by the Invention

It is important to prevent the removal of the connecting portion from the terminal portion by bonding the connecting portion to the terminal portion as in the case of the above-mentioned conventional energy storage device. Accordingly, there has been a demand for strongly fixing the connecting portion to the terminal portion.

The present invention has been made in view of the above-mentioned circumstances, and it is an object of the present invention to provide an energy storage device where a connecting portion can be strongly fixed to a terminal portion, and a method of manufacturing such an energy storage device.

### Means for Solving the Problems

To achieve the object, an energy storage device according to an aspect of the present invention includes: a terminal portion; a current collector; and a connecting portion which connects the terminal portion and the current collector, wherein the terminal portion includes a cylindrical portion which is bottomed at one end side and is open at an other end side, wherein the connecting portion is inserted into and connected to the cylindrical portion, wherein, on an outer surface of the connecting portion, a concave portion of the connecting portion or a convex portion of the connecting portion is formed, and wherein, on an inner surface of the cylindrical portion, a convex portion on the inner surface of the cylindrical portion or a concave portion on the inner surface of the cylindrical portion, which is engaged with the concave portion of the connecting portion or the convex portion of the connecting portion, is formed.

### Advantages of the Invention

According to the present invention, the connecting portion can be strongly fixed to the terminal portion.

### BRIEF DESCRIPTION OF THE DRAWINGS

FIG. 1 is a perspective view schematically showing an external appearance of an energy storage device according to an embodiment.

FIG. 2 is a perspective view showing respective constitutional elements which the energy storage device includes in a state where a case body of a case of the energy storage device according to the embodiment is separated.

FIG. 3 is a partially enlarged cross-sectional view showing a lid body, a negative electrode current collector, a negative electrode terminal and a negative electrode sealing member of the energy storage device according to the embodiment.

FIG. 4 is an enlarged cross-sectional view showing the negative electrode terminal of the energy storage device according to the embodiment.

FIG. 5 is an enlarged cross-sectional view showing an inserting step in a method for manufacturing an energy storage device according to the embodiment.

FIG. 6 is an enlarged cross-sectional view showing an inserting step in a method for manufacturing an energy storage device according to the embodiment.

FIG. 7 is an enlarged cross-sectional view showing a forming step in a method for manufacturing an energy storage device according to the embodiment.

FIG. 8 is an enlarged cross-sectional view showing a resin molding step in a method for manufacturing an energy storage device according to the embodiment.

FIG. 9 is an enlarged cross-sectional view showing a negative electrode terminal of an energy storage device according to a modification of the embodiment.

FIG. 10 is a perspective view showing the cross-sectional configuration of a negative electrode terminal and a periphery of the negative electrode terminal of an energy storage device according to another modification of the embodiment.

### MODE FOR CARRYING OUT THE INVENTION

To achieve the object, an energy storage device according to an aspect of the present invention includes: a terminal portion; a current collector; and a connecting portion which connects the terminal portion and the current collector, wherein the terminal portion includes a cylindrical portion which is bottomed at one end side and is open at an other end side, wherein the connecting portion is inserted into and connected to the cylindrical portion, wherein, on an outer surface of the connecting portion, a concave portion of the connecting portion or a convex portion of the connecting portion is formed, and wherein, on an inner surface of the cylindrical portion, a convex portion on the inner surface of the cylindrical portion or a concave portion on the inner surface of the cylindrical portion, which is engaged with the concave portion of the connecting portion or the convex portion of the connecting portion, is formed.

With such a configuration, the convex portion on the inner surface of the cylindrical portion or the concave portion on the inner surface of the cylindrical portion of the terminal portion is engaged with the concave portion or the convex portion of the connecting portion and hence, the connecting portion can be strongly fixed to the terminal portion. Accordingly, the removal of the connecting portion from the terminal portion can be prevented.

In an energy storage device according to an aspect of the present invention, on an outer surface of the cylindrical portion, a concave portion on the outer surface of the cylindrical portion or a convex portion on the outer surface of the cylindrical portion, may be formed at a position which corresponds to the convex portion on the inner surface of the cylindrical portion or the concave portion on the inner surface of the cylindrical portion.

With such a configuration, on the outer surface of the cylindrical portion, the concave portion or the convex portion is formed corresponding to the convex portion or the concave portion on the inner surface of the cylindrical portion. Accordingly, a thickness of a member which forms the cylindrical portion can be made approximately uniform and hence, it is possible to suppress the occurrence of irregularities in a strength of the cylindrical portion.

In an energy storage device according to an aspect of the present invention, the concave portion of the connecting portion or the convex portion of the connecting portion may be formed annularly.

With such a configuration, the concave portion or the convex portion of the connecting portion is formed annularly. Accordingly, the concave portion or the convex portion can be easily formed or the connecting portion can be connected to the cylindrical portion with a uniform force over the periphery of the connecting portion.

In an energy storage device according to an aspect of the present invention, the connecting portion may include a flange portion which is in contact with at least a part of a surface at the other end side of the cylindrical portion of the terminal portion.

With such a configuration, the cylindrical portion of the terminal portion is in contact with the flange portion of the connecting portion and hence, the connecting portion can be easily positioned with respect to the cylindrical portion.

An energy storage device according to an aspect of the present invention may further include a resin portion which is integrated with the cylindrical portion of the terminal portion and the flange portion of the connecting portion to cover the cylindrical portion and the flange portion.

With such a configuration, the resin portion covers the cylindrical portion of the terminal portion and the flange portion of the connecting portion and hence, the connecting portion can be further strongly fixed to the terminal portion by the resin portion.

In an energy storage device according to an aspect of the present invention, a material of the terminal portion may be aluminum or aluminum alloy, and a material of the connecting portion may be copper or copper alloy.

With such a configuration, the terminal portion is bottomed at one end side and allows the insertion of the connecting portion from the other end side. Accordingly, the connecting portion is not exposed to the outside from the terminal portion and hence, even when the terminal portion and the connecting portion are formed using different kinds of metals, it is possible to suppress the occurrence of electric corrosion caused by condensation or the like between the terminal portion and the connecting portion.

A method of manufacturing an energy storage device according to an aspect of the present invention includes: an inserting step in which a connecting portion, which connects a terminal portion and a current collector, is inserted into a cylindrical portion which is formed in the terminal portion and is bottomed at one end side and is open at an other end side, and a forming step in which, on an inner surface of the cylindrical portion, a convex portion on the inner surface of the cylindrical portion or a concave portion on the inner surface of the cylindrical portion, which corresponds to a concave portion of the connecting portion or a convex portion of the connecting portion on an outer surface of the connection portion, is formed by pressing the cylindrical portion from an outer surface.

With such a manufacturing method, the convex portion on the inner surface of the cylindrical portion or the concave portion on the inner surface of the cylindrical portion of the terminal portion is formed such that the convex portion or the concave portion is engaged with the concave portion of the connecting portion or the convex portion of the connecting portion. Accordingly, the connecting portion can be strongly fixed to the terminal portion. As a result, the removal of the connecting portion from the terminal portion can be prevented.

In a manufacturing method of an energy storage device according to an aspect of the present invention, in the inserting step, the connecting portion, on which the concave portion of the connecting portion or the convex portion of the connecting portion is formed, may be inserted into the cylindrical portion, and, in the formation step, the convex portion on the inner surface of the cylindrical portion or the concave portion on the inner surface of the cylindrical portion in the cylindrical portion, which corresponds to a concave portion of the connecting portion or a convex portion of the connecting portion formed on an outer surface of the connection portion, may be formed by pressing the cylindrical portion from an outer surface toward the connecting portion.

With such a manufacturing method, it is possible to form the convex portion on the inner surface of the cylindrical portion or the concave portion on the inner surface of the cylindrical portion which is engaged with the concave portion of the connecting portion or the convex portion of the connecting portion. Accordingly, compared with a case where the connecting portion and the terminal portion are engaged with each other by threaded engagement or the like, for example, the connecting portion can be strongly fixed to the terminal portion.

### MODE FOR CARRYING OUT THE INVENTION

Hereinafter, an energy storage device according to an embodiment of the present invention is described with reference to drawings. The embodiment described hereinafter is a preferable specific example of the present invention. In the embodiment described hereinafter, numerical values, shapes, materials, constitutional elements, the arrangement positions and connection states of the constitutional elements and the like are merely examples, and these are not intended to be used for limiting the present invention. Further, out of the constitutional elements in the embodiment described hereinafter, the constitutional elements which are not described in independent claims describing an uppermost concept are described as arbitrary constitutional elements.

The respective drawings are schematic drawings where constitutional elements are not always described strictly accurately. Further, in the respective drawings, constitutional elements substantially equal to each other are given the same symbols, and their repeated description is omitted or simplified.

### EMBODIMENT

### [Configuration]

Hereinafter, an energy storage device 10 according to an embodiment of the present invention is described.

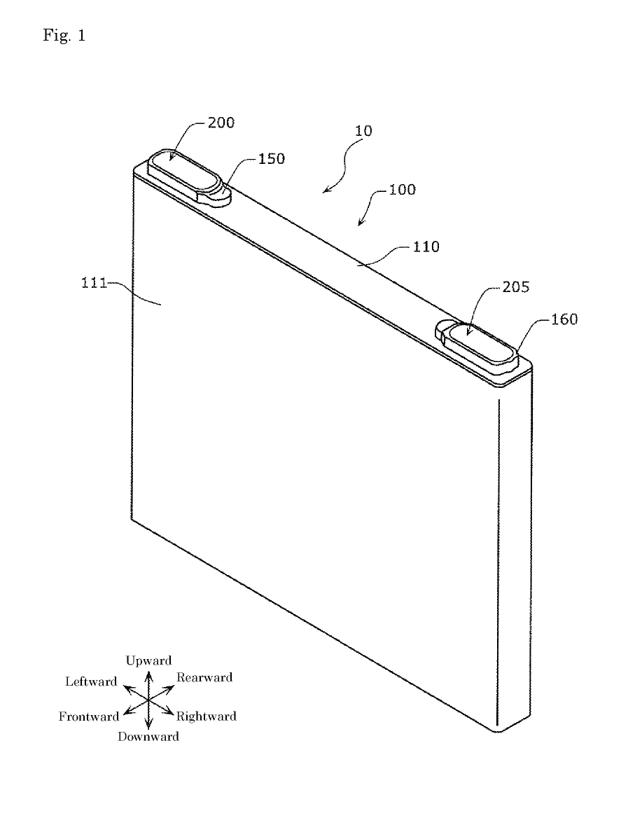

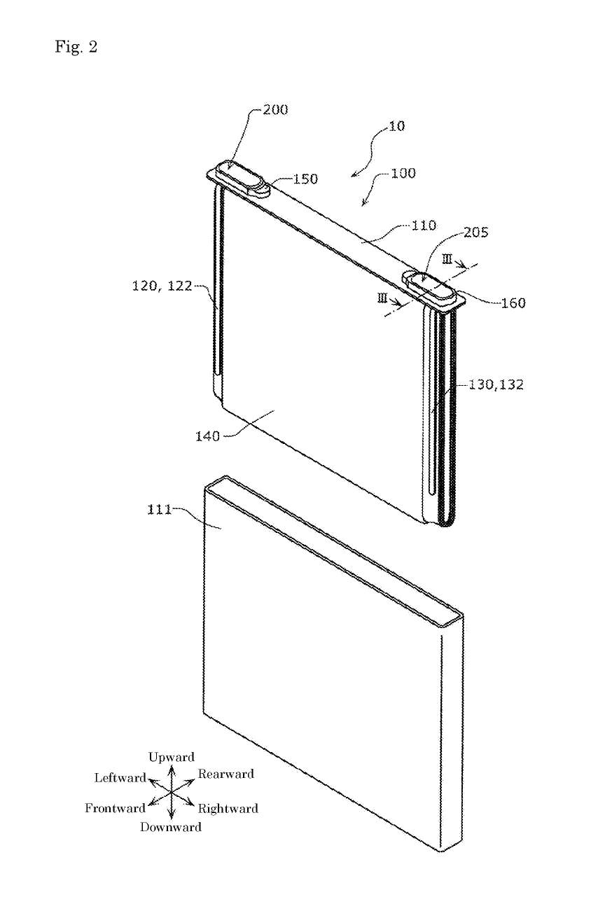

FIG. 1 is a perspective view schematically showing an external appearance of the energy storage device 10 according to the embodiment. FIG. 2 is a perspective view showing respective constitutional elements which the energy storage device 10 includes are shown in a state where a case body 111 of a case 100 of the energy storage device 10 according to the embodiment is separated. In this embodiment, the respective constitutional elements which the energy storage device 10 includes are shown in a state where the case body 111 of the case 100 of the energy storage device 10 is separated.

In FIG. 1, in the energy storage device 10, respective directions, that is, frontward and rearward directions, leftward and rightward directions, and upward and downward directions are shown by defining a positive electrode terminal 200 side of the energy storage device 10 as a left side. All of the respective directions described in the drawings succeeding to FIG. 2 are shown corresponding to respective directions in FIG. 1. Actual upward and downward directions, leftward and rightward directions, and frontward and rearward directions of the energy storage device are changed depending on a mode of use and hence, the present invention is not limited to such a configuration.

The energy storage device 10 is a secondary battery which can charge electricity and can discharge electricity. To be more specific, the energy storage device 10 is a nonaqueous electrolyte secondary battery such as a lithium ion secondary battery. The energy storage device 10 is not limited to a nonaqueous electrolyte secondary battery, and may be a secondary battery other than a nonaqueous electrolyte secondary battery, or may be a capacitor and, further, the energy storage device 10 may be a primary battery where a user can use stored electricity without charging.

As shown in FIG. 1 and FIG. 2, the energy storage device 10 includes: a case 100; a positive electrode current collector 120 (one example of a current collector) and a negative electrode current collector 130 (one example of the current collector); an electrode assembly 140; a positive electrode sealing member 150 (one example of a resin portion) and a negative electrode sealing member 160 (one example of a resin portion); and a positive electrode terminal 200 (one example of terminal portion) and a negative electrode terminal 205 (one example of terminal portion).

Although a liquid such as an electrolyte solution (nonaqueous electrolyte) is sealed in the case 100 of the energy storage device 10, the illustration of such a liquid is omitted. As the electrolyte solution sealed in the case 100, a kind of the electrolyte solution is not particularly limited, and any kind of electrolyte solution can be selected provided that performance of the energy storage device 10 is not impaired.

The case 100 is formed of; the case body 111 which has a bottomed rectangular cylindrical shape; and a lid body 110 which is a plate-like member for closing an opening of the case body 111. The case 100 is configured such that the inside of the case 100 can be hermetically sealed by joining the lid body 110 and the case body 111 to each other by welding or the like after the positive electrode current collector 120, the negative electrode current collector 130, the electrode assembly 140 and the like are accommodated in the inside of the case 100. Materials for forming the lid body 110 and the case body 111 are not particularly limited, for example, it is preferable that the lid body 110 and the case body 111 be made of weldable metal such as stainless steel, aluminum, aluminum alloy, iron or a plated steel sheet.

As shown in FIG. 2, the positive electrode current collector 120 and the negative electrode current collector 130 are disposed in the inside of the case 100, that is, on an inner surface (a lower surface) of the lid body 110. To be more specific, the positive electrode current collector 120 is a member having conductivity and rigidity which is disposed between the positive electrode of the electrode assembly 140 and a side wall of the case body 111, and is electrically connected to the positive electrode terminal 200 and the positive electrode of the electrode assembly 140. The negative electrode current collector 130 is a member having conductivity and rigidity which is disposed between the negative electrode of the electrode assembly 140 and a side wall of the case body 111, and is electrically connected to the negative electrode terminal 205 and the negative electrode of the electrode assembly 140.

The positive electrode current collector 120 is made of aluminum, aluminum alloy or the like in the same manner as the positive electrode substrate foil of the electrode assembly 140 described later. The negative electrode current collector 130 is made of copper, copper alloy or the like in the same manner as the negative electrode substrate foil of the electrode assembly 140 described later.

The positive electrode current collector 120 includes electrode assembly connecting portions 122. The electrode assembly connecting portions 122 are two elongated legs which are electrically connected to the positive electrode of the electrode assembly 140. The negative electrode current collector 130 includes electrode assembly connecting portions 132. The electrode assembly connecting portions 132 are two elongated legs which are electrically connected to the negative electrode of the electrode assembly 140. The electrode assembly connecting portions 122, 132 are disposed below the lid body 110. The electrode assembly connecting portions 122 of the positive electrode current collector 120 are connected to the positive electrode of the electrode assembly 140 by welding such as ultrasonic welding or resistance welding, and the electrode assembly connecting portions 132 of the negative electrode current collector 130 are connected to the positive electrode of the electrode assembly 140 by welding such as ultrasonic welding or resistance welding.

The electrode assembly 140 is an energy storage element (power generating element) which includes a positive electrode, a negative electrode and a separator, and can store electricity. The positive electrode is an electrode formed by forming a positive active material layer on a positive electrode substrate foil which is a metal foil having an elongated strip shape and made of aluminum, aluminum alloy or the like. The negative electrode is an electrode formed by forming a negative active material layer on a negative electrode substrate foil which is a metal foil having an elongated strip shape and made of copper, copper alloy, aluminum, aluminum alloy or the like. Further, the separator is a microporous sheet made of a resin.

As a positive active material for forming the positive active material layer and a negative active material for forming the negative active material layer, a known material can be suitably used provided that the material is a positive active material and a negative active material capable of occluding and discharging lithium ions.

As the positive active material, for example, a polyanion compound such as LiMPO₄, LiMSiO₄, LiMBO₃ (M indicating one kind or two or more kinds of transition metal elements selected from Fe, Ni, Mn, Co and the like) or the like, a spinel compound such as lithium titanate, lithium manganate, a lithium transition metal oxide such as LiMO₂ (M indicating one kind or two or more kinds of transition metal elements selected from Fe, Ni, Mn, Co and the like) can be used.

As the negative active material, for example, in addition to lithium metal and a lithium alloy (alloy containing lithium metal such as lithium-aluminum, lithium-silicon, lithium-lead, lithium-tin, lithium-aluminum-tin, lithium-gallium, and a Wood's alloy), alloy which can occlude and discharge lithium ions, a carbon material (for example, graphite, hardly graphitizable carbon, easily graphitizable carbon, low temperature baked carbon, amorphous carbon or the like), a metal oxide, a lithium metal oxide (Li₄Ti₅O₁₂ or the like), a polyphosphoric acid compound or the like can be named.

The electrode assembly 140 is formed by winding a positive electrode, a negative electrode, and a separator which are arranged in a layered manner with the separator sandwiched between the positive electrode and the negative electrode, and is electrically connected to the positive electrode current collector 120, and the negative electrode current collector 130. In FIG. 2, the electrode assembly 140 having an elongated circular cross section is shown. However, the electrode assembly 140 may have a circular cross section or an elliptical cross section. Further, the electrode assembly 140 is not limited to a winding-type electrode assembly, and may be a stacking-type electrode assembly where flat-plate-like electrode plates are stacked to each other.

Next, a fixing structure is described where the positive electrode terminal 200 is fixed to the lid body 110 together with the positive electrode current collector 120 by way of the positive electrode sealing member 150. Also a fixing structure is described where the negative electrode terminal 205 is fixed to the lid body 110 together with the negative electrode current collector 130 by way of the negative electrode sealing member 160.

The positive electrode sealing member 150 and the negative electrode sealing member 160 are gaskets, where at least a portion of the positive electrode sealing member 150 is disposed between the positive electrode terminal 200 and the lid body 110 and a portion of the negative electrode sealing member 160 is disposed between the negative electrode terminal 205 and the lid body 110 respectively. The positive electrode sealing member 150 covers an outer periphery of the positive electrode terminal 200, and covers an upper side of the positive electrode current collector 120 thus fixing the positive electrode terminal 200 to the lid body 110. On the other hand, the negative electrode sealing member 160 covers an outer periphery of the negative electrode terminal 205, and covers an upper side of the negative electrode current collector 130 thus fixing the negative electrode terminal 205 to the lid body 110. With such a configuration, the positive electrode terminal 200 and the negative electrode terminal 205 are mounted on the lid body 110 in a state where a portion of the electrode terminal is exposed. In this manner, the positive electrode terminal 200, the positive electrode sealing member 150 and the positive electrode current collector 120 are integrally fixed to the lid body 110. On the other hand, the negative electrode terminal 205, the negative electrode sealing member 160 and the negative electrode current collector 130 are integrally fixed to the lid body 110.

It is preferable that the positive electrode sealing member 150 and the negative electrode sealing member 160 be formed of a member having lower rigidity than the lid body 110 and having an insulating property. For example, the positive electrode sealing member 150 and the negative electrode sealing member 160 are made of a resin such as polyphenylene sulfide (PPS), polypropylene (PP), polyethylene (PE), polybutylene terephthalate (PBT), polytetrafluoroethylene (PFA), polyether ether ketone (PEEK) or a phenol resin. While these sealing members may be made of a kind of resin material, these sealing members may be also made of a combination of plural kinds of resin materials, a combination of a resin material and an elastomer material, or a material formed by adding a granular or fibrous inorganic material into a resin material.

The positive electrode terminal 200 is an electrode terminal which is disposed outside the case 100, and is electrically connected to the positive electrode of the electrode assembly 140. The negative electrode terminal 205 is an electrode terminal which is disposed outside the case 100, and is electrically connected to the negative electrode of the electrode assembly 140. That is, the positive electrode terminal 200 and the negative electrode terminal 205 are conductive electrode terminals through which electricity stored in the electrode assembly 140 is discharged to a space outside the energy storage device 10, and through which electricity is introduced into a space inside the energy storage device 10 for storing the electricity in the electrode assembly 140. The positive electrode terminal 200 and the negative electrode terminal 205 are mounted on the lid body 110 by way of the positive electrode sealing member 150 and the negative electrode sealing member 160 respectively.

Next, the structure of the negative electrode terminal 205 of the energy storage device 10 is described in detail. The structure of the positive electrode terminal 200 may be the structure substantially equal to the structure of the negative electrode terminal 205 described later, or may be the structure described later where the terminal portion 210 and the connecting portion 230 are integrally formed with each other. The detailed structure of the positive electrode terminal 200 is omitted. In this manner, the positive electrode terminal 200 and the negative electrode terminal 205 may have different configurations provided that such configurations do not depart from the gist of the present invention.

For example, the terminal portion 210 of the negative electrode terminal 205 is made of aluminum, aluminum alloy or the like, and the connecting portion 230 is made of copper, copper alloy or the like. Further, for example, when the positive electrode terminal 200 is an integral part formed of the terminal portion 210 and the connecting portion 230, the positive electrode terminal 200 is made of aluminum or aluminum alloy

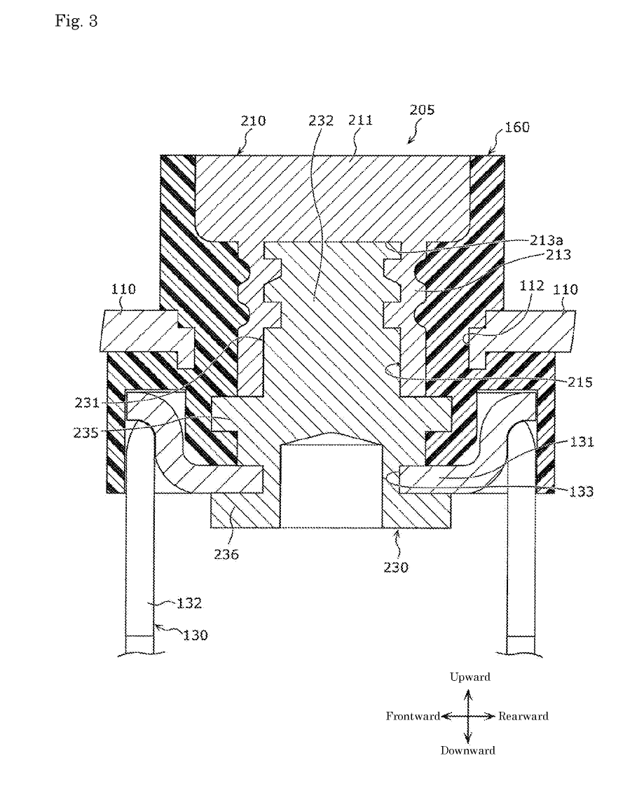

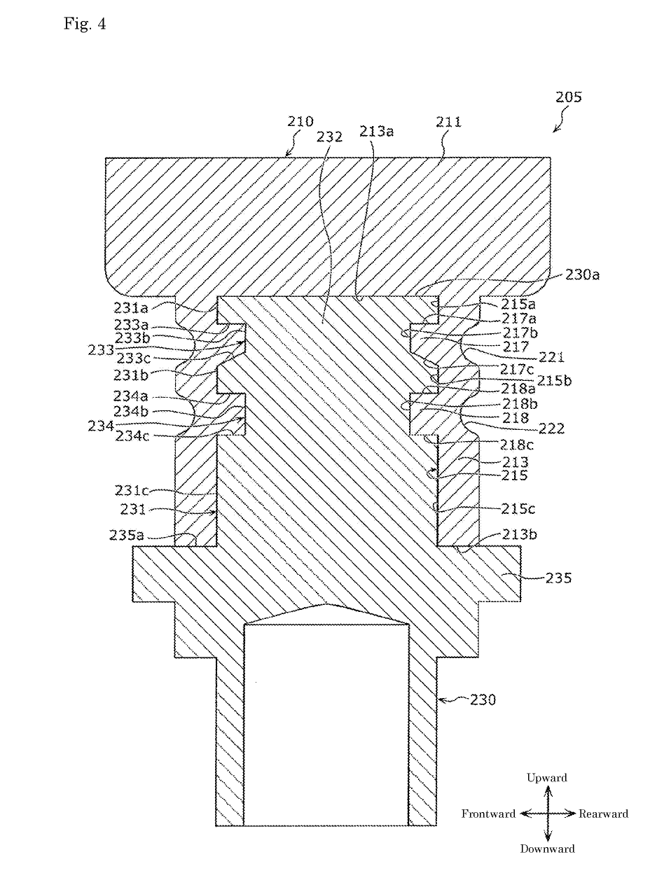

FIG. 3 is a partially enlarged cross-sectional view showing the lid body 110, the negative electrode current collector 130, the negative electrode terminal 205 and the negative electrode sealing member 160 of the energy storage device 10 according to the embodiment. FIG. 3 is a cross-sectional view in a plane defined by a vertical direction and a longitudinal direction including a line III-III in FIG. 2 as viewed in a left direction. FIG. 4 is an enlarged cross-sectional view showing the negative electrode terminal 205 of the energy storage device 10 according to the embodiment, and shows a state before a tip of the connecting portion 230 is swaged.

As shown in FIG. 3, the negative electrode terminal 205 is fixed to the lid body 110 by the negative electrode sealing member 160 in a state where the negative electrode terminal 205 passes through a through hole 112 formed in the lid body 110. The negative electrode terminal 205 includes: the terminal portion 210, and a connecting portion 230 which connects the terminal portion 210 and the negative electrode current collector 130 to each other. To be more specific, the terminal portion 210 includes: a body portion 211 and a cylindrical portion 213. The connecting portion 230 includes: the shaft portion 232; a flange portion 235; and a swaged portion 236 formed by being swaged in a direction toward the negative electrode current collector 130.

The body portion 211 is a plate-like portion to which a bus bar or external equipment is connected, and an upper surface of the body portion 211 forms a planar surface. The cylindrical portion 213 projects in an approximately cylindrical shape downward from a lower surface (a surface on a negative electrode current collector 130 side) of the body portion 211. The cylindrical portion 213 is closed at an upper side and is open at a lower side. A bottom surface 213a of the cylindrical portion 213 forms a lower surface of the body portion 211. An insertion hole 215 is formed in the cylindrical portion 213. The approximately circular columnar shaft portion 232 formed on an upper portion of the flange portion 235 of the connecting portion 230 is inserted into the insertion hole 215 (an inner surface of the cylindrical portion 213). The insertion hole 215 of the cylindrical portion 213 has the same shape as an outer periphery of the shaft portion 232. The cylindrical portion 213 fastens the shaft portion 232 from a periphery of the shaft portion 232. To be more specific, the cylindrical portion 213 fastens the shaft portion 232 which is a portion disposed above the flange portion 235 from the periphery of the shaft portion 232. A bottom surface 213a of the cylindrical portion 213 is an example of one end side of the cylindrical portion 213, and a lower end surface 213b of the cylindrical portion 213 is one example of the other end side of the cylindrical portion 213. That is, the cylindrical portion 213 is a portion which has a bottom at one end side and is open at the other end side.

As shown in FIG. 4, on the cylindrical portion 213, a first convex portion on an inner surface of the cylindrical portion 217 (one example of a convex portion on an inner surface of the cylindrical portion), a second convex portion on an inner surface of the cylindrical portion 218 (an example of a convex portion on an inner surface of the cylindrical portion), a first cylindrical portion outer surface side concave portion 221 (one example of a cylindrical portion outer surface side concave portion) and, a second cylindrical portion outer surface side concave portion 222 (one example of a cylindrical portion outer surface side concave portion) are formed.

In the insertion hole 215 of the cylindrical portion 213, a first inner peripheral surface 215a, a first cylindrical portion inner surface side convex portion 217, a second inner peripheral surface 215b, a second cylindrical portion inner surface side convex portion 218, and a third inner peripheral surface 215c are formed in order from above to below.

The first inner peripheral surface 215a extends in a vertical direction from an outer peripheral edge of a bottom surface 213a of the cylindrical portion 213.

The first cylindrical portion inner surface side convex portion 217 annularly projects toward an axis of the cylindrical portion 213 from between the first inner peripheral surface 215a and the second inner peripheral surface 215b. The first cylindrical portion inner surface side convex portion 217 is formed of a first cylindrical portion inner surface side contact surface 217a; a first cylindrical portion inner surface side tip contact surface 217b; and a second cylindrical portion inner surface side contact surface 217c. A first cylindrical portion inner surface side contact surface 217a forms an upper surface of the first cylindrical portion inner surface side convex portion 217. The first cylindrical portion inner surface side tip contact surface 217b is a tip surface of the first cylindrical portion inner surface side convex portion 217. The second cylindrical portion inner surface side contact surface 217c is a lower surface of the first cylindrical portion inner surface side convex portion 217. The second cylindrical portion inner surface side contact surface 217c is inclined downward toward an outer peripheral side from the axis of the cylindrical portion 213 when the cylindrical portion 213 shown in FIG. 4 is viewed in cross section.

The second cylindrical portion inner surface side convex portion 218 annularly projects toward the axis of the cylindrical portion 213 between the second inner peripheral surface 215b and the third inner peripheral surface 215c. The second cylindrical portion inner surface side convex portion 218 is formed of a third cylindrical portion inner surface side contact surface 218a; a second cylindrical portion inner surface side tip contact surface 218b; and a fourth cylindrical portion inner surface side contact surface 218c. The third cylindrical portion inner surface side contact surface 218a is an upper surface of the second cylindrical portion inner surface side convex portion 218. The second cylindrical portion inner surface side tip contact surface 218b is a tip surface of the second cylindrical portion inner surface side convex portion 218. The fourth cylindrical portion inner surface side contact surface 218c is a lower surface of the second cylindrical portion inner surface side convex portion 218.

The first inner peripheral surface 215a, the second inner peripheral surface 215b and the third inner peripheral surface 215c have the same diameter respectively.

It is preferable that the axes of the first inner peripheral surface 215a, the first cylindrical portion inner surface side convex portion 217, the second inner peripheral surface 215b, the second cylindrical portion inner surface side convex portion 218 and the third inner peripheral surface 215c agree with the axis of the cylindrical portion 213. However, the axes of these portions may be different from each other. The insertion hole 215 may have a tapered surface or a curved surface as viewed in cross section shown in FIG. 4. When the insertion hole 215 has a tapered surface or a curved surface, it is preferable that a diameter of the insertion hole 215 is decreased from an opening of the cylindrical portion 213 toward the body portion 211.

The first cylindrical portion outer surface side concave portion 221 is a groove concaved annularly from an outer surface of the cylindrical portion 213 toward an axis of the cylindrical portion 213. The first cylindrical portion outer surface side concave portion 221 is formed at a position corresponding to the first cylindrical portion inner surface side convex portion 217, and is positioned outside the first cylindrical portion inner surface side convex portion 217. A second cylindrical portion outer surface side concave portion 222 is formed at a position corresponding to the second cylindrical portion inner surface side convex portion 218, and is disposed outside the second cylindrical portion inner surface side convex portion 218.

The first cylindrical portion outer surface side concave portion 221 and the second cylindrical portion outer surface side concave portion 222 are annular grooves having a semicircular shape as viewed in cross section shown in FIG. 4.

The connecting portion 230 includes: a shaft portion 232 having an outer peripheral surface 231 on which the first connecting portion side concave portion 233 (one example of the connecting portion side concave portion) and the second connecting portion side concave portion 234 (one example of the connecting portion side concave portion) are formed; a flange portion 235; and a hollow tip portion swaged to the negative electrode current collector 130.

On the outer peripheral surface 231 of the shaft portion 232, a first outer peripheral surface 231a, the first connecting portion side concave portion 233, a second outer peripheral surface 231b, the second connecting portion side concave portion 234, and a third outer peripheral surface 231c are formed in order from above to below.

The first outer peripheral surface 231a extends in a vertical direction from an outer peripheral edge of a tip surface 230a of the shaft portion 232. The tip surface 230a of the shaft portion 232 is brought into contact with the bottom surface 213a of the cylindrical portion 213. The first outer peripheral surface 231a is brought into contact with the first inner peripheral surface 215a of the cylindrical portion 213.

The first connecting portion side concave portion 233 is a groove annularly concaved toward an axis from the outer peripheral surface 231 of the shaft portion 232 between the first outer peripheral surface 231a and the second outer peripheral surface 231b.

The first connecting portion side concave portion 233 is formed of a first connecting portion side contact surface 233a; a first connecting portion side contact bottom surface 233b; and a second connecting portion side contact surface 233c. The first connecting portion side contact surface 233a is an upper surface of the first connecting portion side concave portion 233. The first connecting portion side contact surface 233a is brought into contact with a first cylindrical portion inner surface side contact surface 217a of the cylindrical portion 213. The first connecting portion side contact bottom surface 233b is a bottom surface of the first connecting portion side concave portion 233. The first connecting portion side contact bottom surface 233b is brought into contact with a first cylindrical portion inner surface side tip contact surface 217b of the cylindrical portion 213. The second connecting portion side contact surface 233c is a lower surface of the first connecting portion side concave portion 233. The second connecting portion side contact surface 233c is, as viewed in a cross section of the shaft portion 232 shown in FIG. 4, inclined downward from the axis of the shaft portion 232 to the second outer peripheral surface 231b of the shaft portion 232. The second connecting portion side contact surface 233c is brought into contact with the second cylindrical portion inner surface side contact surface 217c of the cylindrical portion 213. The second outer peripheral surface 231b is brought into contact with the second inner peripheral surface 215b of the cylindrical portion 213.

The second connecting portion side concave portion 234 is a groove annularly concaved from the outer peripheral surface of the shaft portion 232 toward the axis of the shaft portion 232 between the second outer peripheral surface 231b and the third outer peripheral surface 231c.

The second connecting portion side concave portion 234 is formed of; a third connecting portion side contact surface 234a; a second connecting portion side contact bottom surface 234b; and a fourth connecting portion side contact surface 234c. The third connecting portion side contact surface 234a is an upper surface of the second connecting portion side concave portion 234. The third connecting portion side contact surface 234a is brought into contact with the third cylindrical portion inner surface side contact surface 218a of the cylindrical portion 213. The second connecting portion side contact bottom surface 234b is a bottom surface of the second connecting portion side concave portion 234. The second connecting portion side contact bottom surface 234b is brought into contact with the second cylindrical portion inner surface side tip contact surface 218b of the cylindrical portion 213. The fourth connecting portion side contact surface 234c is a lower surface of the second connecting portion side concave portion 234. The fourth connecting portion side contact surface 234c is brought into contact with the fourth cylindrical portion inner surface side contact surface 218c of the cylindrical portion 213. The third outer peripheral surface 231c is brought into contact with the third inner peripheral surface 215c of the cylindrical portion 213. In this manner, a gap is not formed between the cylindrical portion 213 and the shaft portion 232 and hence, a large contact area can be ensured between the shaft portion 232 and the cylindrical portion 213 whereby an electric conduction resistance can be lowered.

The first outer peripheral surface 231a, the second outer peripheral surface 231b, and the third outer peripheral surface 231c respectively have the same diameter and form an outer peripheral surface of the shaft portion 232.

It is preferable that an axis of the first outer peripheral surface 231a, an axis of the first connecting portion side concave portion 233, an axis of the second outer peripheral surface 231b, an axis of the second connecting portion side concave portion 234, and an axis of the third outer peripheral surface 231c agree with the axis of the shaft portion 232. However, the axes of the respective surfaces and portions may differ from each other. The outer peripheral surface 231 of the shaft portion 232 may be formed in a tapered surface or a curved surface as viewed in cross section shown in FIG. 4. When the outer peripheral surface 231 of the shaft portion 232 is formed in a tapered surface or a curved surface, it is preferable that a diameter of the outer peripheral surface 231 is decreased from a flange portion 235 side to a body portion 211 side in cross section.

A depth of the first connecting portion side concave portion 233 and a depth of the second connecting portion side concave portion 234 can be changed as desired. Corresponding to a depth of the first connecting portion side concave portion 233 and a depth of the second connecting portion side concave portion 234, a protrusion amount of the first cylindrical portion inner surface side convex portion 217 and a protrusion amount of the second cylindrical portion inner surface side convex portion 218 are determined.

The flange portion 235 of the connecting portion 230 is formed more on a negative electrode current collector 130 side than a tip of the cylindrical portion 213 of the terminal portion 210, and has a larger profile size than the cylindrical portion 213 thus projecting outward from an opening of the cylindrical portion 213. In other words, the flange portion 235 is an annular flange which projects from an outer periphery of a lower edge of the shaft portion 232. An upper end surface 235a of the flange portion 235 is brought into contact with a lower end surface 213b of the cylindrical portion 213 (one example of a surface of the cylindrical portion on the other end side). It is preferable that a length that the flange portion 235 projects from the outer peripheral surface 231 of the shaft portion 232 be set larger than a thickness of the cylindrical portion 213. However, such a projection length of the flange portion 235 is not limited to such a value, and may be smaller than the thickness of the cylindrical portion 213.

As shown in FIG. 3, the negative electrode current collector 130 includes a current collector body portion 131 and the electrode assembly connecting portions 132 as integral portions thereof. The current collector body portion 131 is a portion to which the connecting portion 230 is connected. To be more specific, the current collector body portion 131 includes a planar flat plate portion and side walls which extend in an upward direction from the flat plate portion, and the side walls surround a periphery of the through hole 133 which penetrates a lower portion of the connecting portion 230. An upper side of the current collector body portion 131 is covered by the negative electrode sealing member 160.

The electrode assembly connecting portions 132 of the negative electrode current collector 130 are two elongated legs electrically connected to the negative electrode of the electrode assembly 140 shown in FIG. 2. The electrode assembly connecting portions 132 extend downward from both ends of the current collector body portion 131. The electrode assembly connecting portions 132 are connected to the negative electrode of the electrode assembly 140 shown in FIG. 2 by welding such as ultrasonic welding, resistance welding or the like.

### [Manufacturing Method]

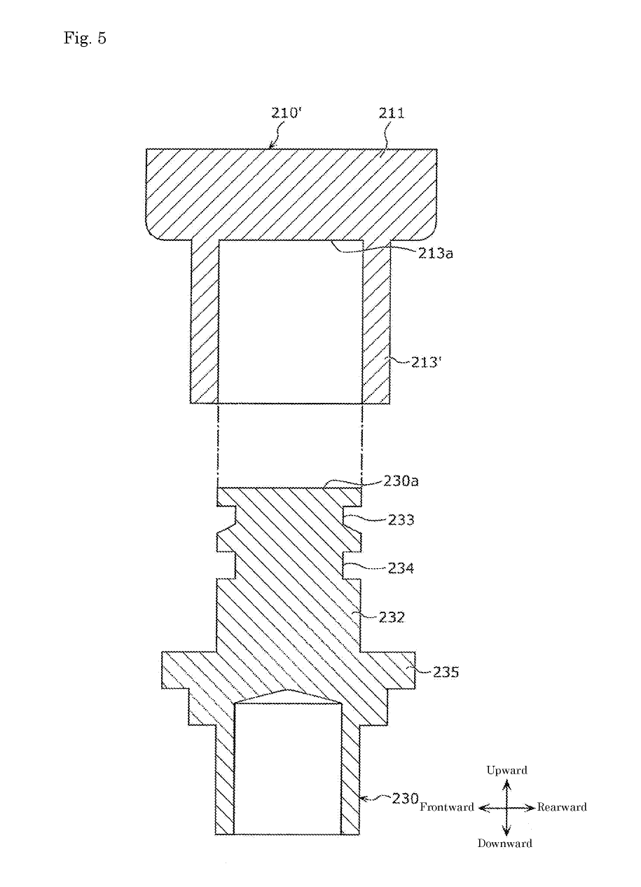

Next, a method for manufacturing the energy storage device 10 is described with reference to FIG. 5 to FIG. 8.

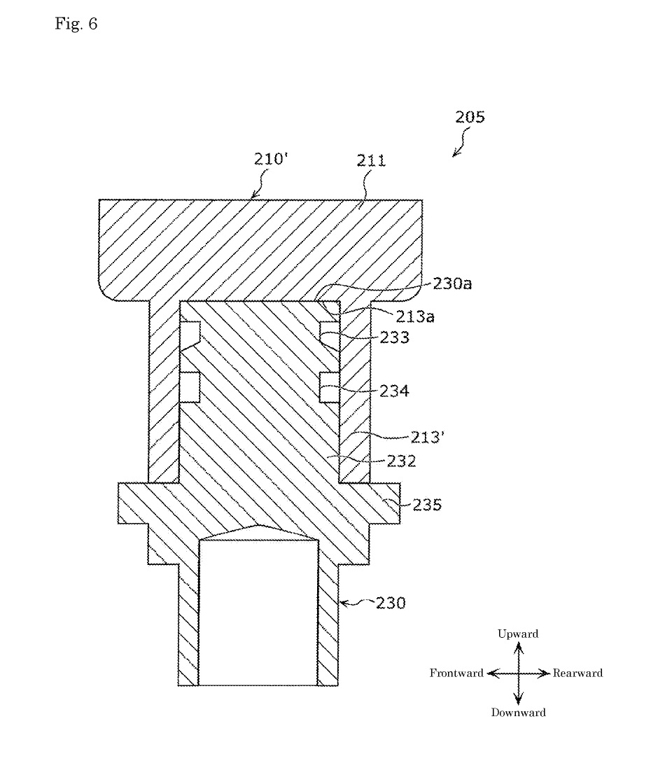

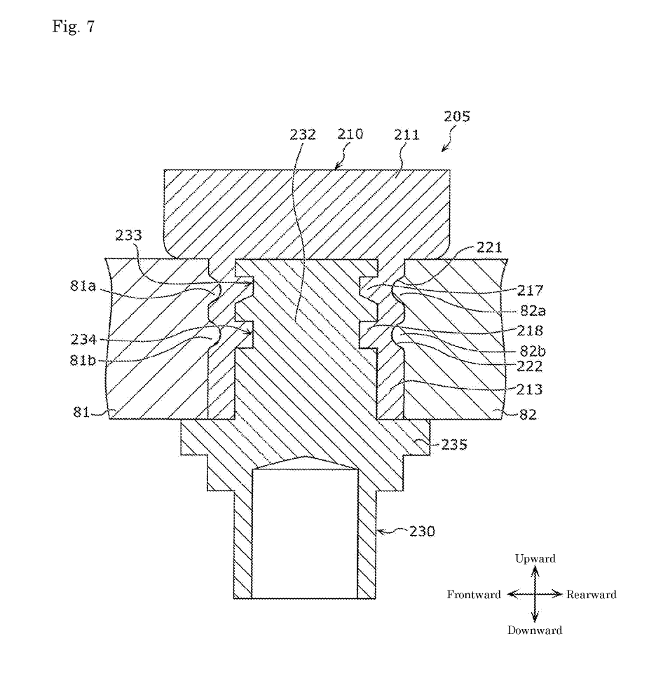

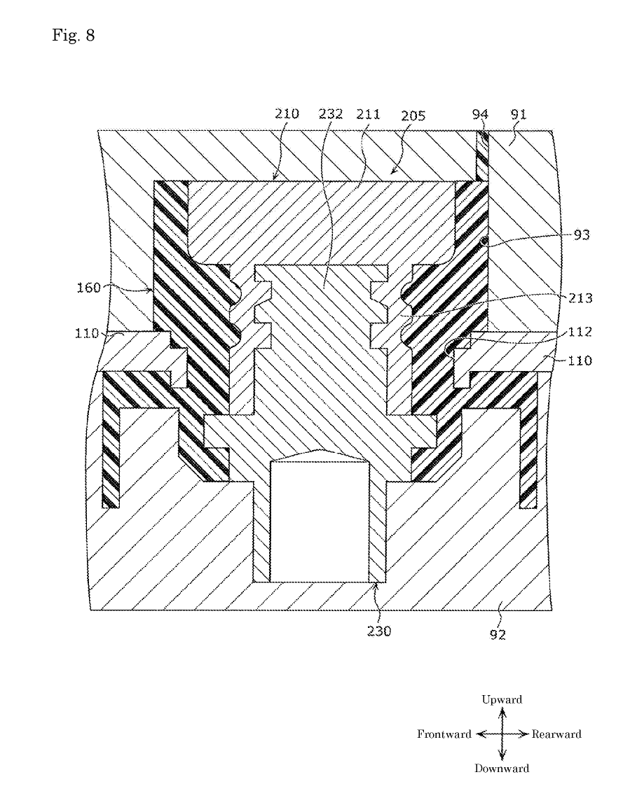

FIG. 5 and FIG. 6 are enlarged cross-sectional views showing an inserting step in the method for manufacturing the energy storage device 10 according to the embodiment. FIG. 7 is an enlarged cross-sectional view showing a forming step in the method for manufacturing the energy storage device 10 according to the embodiment. FIG. 8 is an enlarged cross-sectional view showing a resin molding step in the method for manufacturing the energy storage device 10 according to the embodiment.

First, in the manufacture of the energy storage device 10, the negative electrode terminal is manufactured. To be more specific, as shown in FIG. 5, a terminal portion 210′ and the connecting portion 230 are prepared. Then, the terminal portion 210′ and the connecting portion 230 are disposed such that an axis of a cylindrical portion 213′ of the terminal portion 210′ and the axis of the shaft portion 232 of the connecting portion 230 agree with each other. Then, as shown in FIG. 6, the shaft portion 232 of the connecting portion 230 is inserted into the cylindrical portion 213′ from an opening of the cylindrical portion 213′. At this stage of operation, it is preferable that the insertion of the shaft portion 232 into the cylindrical portion 213′ of the terminal portion 210′ be performed with light press fitting. However, the insertion of the shaft portion 232 may be performed by press fitting other than light press fitting. Further, in the inserting step, neither convex portions nor concave portions are formed on the cylindrical portion 213′ of the terminal portion 210′ so that the cylindrical portion 213′ has a straight cylindrical surface.

Next, the member in a state shown in FIG. 6 where the shaft portion 232 is inserted into the cylindrical portion 213′ is set in a press machine not shown in the drawing. As shown in FIG. 7, the press machine has a first die 81 and a second die 82. The first die 81 and the second die 82 have inverted shapes corresponding to an outer surface of the cylindrical portion 213.

On inner peripheral surfaces of the first die 81 and the second die 82, first die convex portions 81a, 82a which correspond to the first cylindrical portion outer surface side concave portion 221 of the cylindrical portion 213 and second die convex portions 81b, 82b which correspond to the second cylindrical portion outer surface side concave portion 222 of the cylindrical portion 213 are formed. When the first die 81 and the second die 82 are viewed in an inserting direction (in a vertical direction) the first die convex portions 81a, 82a have an annular shape, and the second die convex portions 81b, 82b have an annular shape. When the member in a state shown in FIG. 6 where the shaft portion 232 is inserted into the cylindrical portion 213′ is set in the press machine, the first die convex portions 81a, 82a are disposed at a position where the first die convex portions 81a, 82a correspond to the first connecting portion side concave portion 233, and the second die convex portions 81b, 82b are arranged at a position where the second die convex portions 81b, 82b correspond to the second connecting portion side concave portion 234.

As shown in FIG. 7, the press machine presses the member in a state shown in FIG. 6 where the shaft portion 232 is inserted into the cylindrical portion 213′ from the outer periphery of the cylindrical portion 213′ toward the shaft portion 232 shown in in FIG. 6. The first cylindrical portion inner surface side convex portion 217 and the second cylindrical portion inner surface side convex portion 218 are formed on the inner surface of the cylindrical portion 213, and the first cylindrical portion outer surface side concave portion 221 and the second cylindrical portion outer surface side concave portion 222 are formed on the outer surface of the cylindrical portion 213. In other words, an inverted shape of the outer peripheral surface 231 of the shaft portion 232 is formed on the inner surface of the cylindrical portion 213. With such operations, it is possible to acquire the negative electrode terminal 205 where the terminal portion 210 and the connecting portion 230 are integrally formed with each other. In this embodiment, the first cylindrical portion inner surface side convex portion 217 and the second cylindrical portion inner surface side convex portion 218 are molded using the dies in this embodiment. However, these cylindrical portion inner surface side convex portions may be molded by rolling.

Next, as shown in FIG. 8, a first injection molding die 91 and a second injection molding 92 are prepared. A cavity 93 is formed between the first injection molding die 91 and the second injection molding die 92. A gate 94 is formed in the first injection molding die 91, and an injected molten resin flows into the cavity 93 through the gate 94. The cavity 93 is formed into a shape so as to allow a molten resin to cover portions from side surfaces of the body portion 211 (surfaces on a longitudinal direction side and surfaces on a lateral direction side of the body portion 211) to an outer surface of the cylindrical portion 213, an upper end surface 235a of the flange portion 235 of the connecting portion 230, a side surface of the flange portion 235, a lower end surface of the flange portion 235 (a surface of the flange portion 235 on a side opposite to the upper end surface 235a, a surface on a negative electrode current collector 130 side), and the current collector body portion 131 of the negative electrode current collector 130.

As shown in FIG. 8, the negative electrode terminal 205 which is an integral body formed of the terminal portion 210 and the connecting portion 230 is disposed in the inside of the cavity 93 in a state where the negative electrode terminal 205 passes through the inside of the through hole 112 formed in the lid body 110 while preventing the negative electrode terminal 205 from coming into contact with the lid body 110. Next, resin molding is performed where a molten resin is injected into the cavity 93. With such an operation, as shown in FIG. 8, a molded body where the negative electrode terminal 205 and the lid body 110 are integrally connected to each other by insert molding is obtained. In this insert molded body, the negative electrode terminal 205 and the lid body 110 are insulated from each other by the negative electrode sealing member 160, and gastightness between the negative electrode terminal 205 and the lid body 110 is kept by the negative electrode sealing member 160.

Then, in the molded product obtained in this manner, a hollow portion formed on a lower end side of the connecting portion 230 is swaged to the negative electrode current collector 130 thus forming the swaged portion 236 shown in FIG. 3. Accordingly, the terminal portion 210 is connected to the negative electrode current collector 130.

### [Manner of Operation and Advantageous Effects]

Next, manner of operation and advantageous effects of the energy storage device 10 and the method for manufacturing the energy storage device 10 according to this embodiment are described. The manner of operation and advantageous effects are described mainly with respect to a negative electrode side. However, when a positive electrode side has substantially the same structure as the negative electrode side, the positive electrode side can also acquire the manner of operation and advantageous effects substantially equal to the manner of operation and advantageous effects acquired on the negative electrode side and hence, the description of such a manner of operation and advantageous effects is omitted.

As described previously, the energy storage device 10 according to the embodiment includes: the terminal portion 210; the negative electrode current collector 130; and the connecting portion 230 which connects the terminal portion 210 and the negative electrode current collector 130 to each other. The terminal portion 210 includes the cylindrical portion 213 which is bottomed at a body portion 211 side and is open at a negative electrode current collector 130 side. The connecting portion 230 is inserted into and connected to the cylindrical portion 213. On the outer surface of the connecting portion 230, the first connecting portion side concave portion 233 and the second connecting portion side concave portion 234 are formed. On the inner surface of the cylindrical portion 213, the first cylindrical portion inner surface side convex portion 217 and the second cylindrical portion inner surface side convex portion 218 which are engaged with the first connecting portion side concave portion 233 and the second connecting portion side concave portion 234 of the connecting portion 230 are formed.

With such a configuration, the first cylindrical portion inner surface side convex portion 217 and the second cylindrical portion inner surface side convex portion 218 of the cylindrical portion 213 are engaged with the first connecting portion side concave portion 233 and the second connecting portion side concave portion 234 of the connecting portion 230 respectively. Accordingly, the removal of the connecting portion 230 from the terminal portion 210 can be prevented.

In the energy storage device 10 according to the embodiment, on the outer surface of the cylindrical portion 213, the first cylindrical portion outer surface side concave portion 221 and the second cylindrical portion outer surface side concave portion 222 are formed at positions which correspond to the first cylindrical portion inner surface side convex portion 217 and the second cylindrical portion inner surface side convex portion 218.

With such a configuration, on the outer surface of the cylindrical portion 213, the first cylindrical portion outer surface side concave portion 221 and the second cylindrical portion outer surface side concave portion 222 are formed corresponding to the first cylindrical portion inner surface side convex portion 217 and the second cylindrical portion inner surface side convex portion 218 on the inner surface of the insertion hole 215. Accordingly, a thickness of the member which forms the cylindrical portion 213 can be made approximately uniform and hence, it is possible to suppress the occurrence of irregularities in a strength of the cylindrical portion 213.

Further, the outer peripheral surface of the cylindrical portion 213 is formed into a concavo-convex shape and hence, the inner peripheral surface of the negative electrode sealing member 160 is also formed into a concavo-convex shape. Accordingly, it is possible to enhance resistance against a tensile load applied to the negative electrode terminal 205. That is, in an energy storage apparatus (assembled battery), which includes the plurality of energy storage devices 10, the configuration is adopted where terminals of the energy storage devices 10 disposed adjacently to each other are connected to each other by the bus bar. In such a configuration, the case 100 of the energy storage device 10 is bulged due to the use of the energy storage device 10 and hence, a load is applied to the terminal. Accordingly, it is necessary to increase a resistance against a tensile load applied to the terminal of the energy storage device 10. In this embodiment, the cylindrical portion 213 and the negative electrode sealing member 160 are engaged with each other by the concavo-convex structure and hence, a resistance against a tensile load applied to the negative electrode terminal 205 can be enhanced whereby it is possible to suppress the occurrence of damage on the negative electrode terminal 205.

In the energy storage device 10 according to the embodiment, the first connecting portion side concave portion 233 and the second connecting portion side concave portion 234 are formed annularly.

With such a configuration, the first connecting portion side concave portion 233 and the second connecting portion side concave portion 234 of the connecting portion 230 are formed annularly and hence, the first connecting portion side concave portion 233 and the second connecting portion side concave portion 234 can be easily formed, and can be connected with the cylindrical portion 213 with a uniform force over the periphery of the connecting portion 230.

In the energy storage device 10 according to the embodiment, the connecting portion 230 includes the flange portion 235 which is in contact with at least a part of the lower end surface 213b of the cylindrical portion 213 of the terminal portion 210.

With such a configuration, the cylindrical portion 213 of the terminal portion 210 is in contact with the flange portion 235 of the connecting portion 230 and hence, the connecting portion 230 can be easily positioned with respect to the cylindrical portion 213.

The energy storage device 10 according to the embodiment further includes the negative electrode sealing member 160 which is integrated with the cylindrical portion 213 of the terminal portion 210 and the flange portion 235 of the connecting portion 230 to cover the cylindrical portion 213 and the flange portion 235.

With such a configuration, the negative electrode sealing member 160 covers the cylindrical portion 213 of the terminal portion 210 and the flange portion 235 of the connecting portion 230 and hence, the connecting portion 230 can be further strongly fixed to the terminal portion 210 by the negative electrode sealing member 160. Further, the negative electrode sealing member 160 covers not only the cylindrical portion 213 but also the flange portion 235 and hence, the terminal portion 210 is minimally removed from the resin due to an anchoring effect generated by the flange portion 235.

Particularly, when the negative electrode sealing member 160 is formed by insert molding, the negative electrode sealing member 160 can be made compact and hence, the reduction of a manufacturing cost can be realized.

In the energy storage device 10 according to the embodiment, a material of the terminal portion 210 of the negative electrode terminal 205 is aluminum or aluminum alloy, and a material of the connecting portion 230 is copper or copper alloy.

With such a configuration, the terminal portion 210 is bottomed at a body portion 211 side and allows the insertion of the connecting portion 230 from a negative electrode current collector 130 side. Accordingly, the connecting portion 230 is not exposed to the outside from the terminal portion 210 and hence, even when the terminal portion 210 and the connecting portion 230 are formed using different kinds of metals, it is possible to suppress the occurrence of electric corrosion caused by condensation or the like between the terminal portion 210 and the connecting portion 230.

Particularly, in the case where a material of the terminal portion 210 of the negative electrode terminal 205 is aluminum or aluminum alloy, when the cylindrical portion 213 is plastically strained due to the formation of the first cylindrical portion outer surface side concave portion 221 and the second cylindrical portion outer surface side concave portion 222, a new surface is exposed on the insertion hole 215 and hence, an electric conduction resistance with the connecting portion 230 can be lowered. Further, copper is harder than aluminum and hence, by forming the connecting portion 230 using copper, a strength on a negative electrode side can be enhanced.

As described previously, the method for manufacturing the energy storage device 10 according to the embodiment includes: the inserting step in which the connecting portion 230 which connects the terminal portion 210 and the negative electrode current collector 130 is inserted into the cylindrical portion 213 which is formed in the terminal portion 210 and is bottomed at a body portion 211 side and is open at a negative electrode current collector 130 side; and the forming step in which, on the inner surface of the cylindrical portion 213, the first cylindrical portion inner surface side convex portion 217 and the second cylindrical portion inner surface side convex portion 218 which correspond to the first connecting portion side concave portion 233 and the second connecting portion side concave portion 234 on an outer surface of the connecting portion 230 are formed by pressing the cylindrical portion 213 from an outer surface.

With such a manufacturing method, the first cylindrical portion inner surface side convex portion 217 and the second cylindrical portion inner surface side convex portion 218 of the cylindrical portion 213 of the terminal portion 210 can be formed such that the first cylindrical portion inner surface side convex portion 217 and the second cylindrical portion inner surface side convex portion 218 are engaged with the first connecting portion side concave portion 233 and the second connecting portion side concave portion 234 of the connecting portion 230. Accordingly, the removal of the connecting portion 230 from the terminal portion 210 can be prevented.

In the method for manufacturing the energy storage device 10 according to the embodiment, in the inserting step, the connecting portion 230 on which the first connecting portion side concave portion 233 and the second connecting portion side concave portion 234 are formed is inserted into the cylindrical portion 213. Then, in the forming step, the first cylindrical portion inner surface side convex portion 217 and the second cylindrical portion inner surface side convex portion 218 of the cylindrical portion 213 which correspond to the first connecting portion side concave portion 233 and the second connecting portion side concave portion 234 formed on the outer surface of the connecting portion 230 are formed by pressing the cylindrical portion 213 from the outer surface toward the connecting portion 230.

With such a manufacturing method, it is possible to form the first cylindrical portion inner surface side convex portion 217 and the second cylindrical portion inner surface side convex portion 218 of the cylindrical portion 213 which are engaged with the first connecting portion side concave portion 233 and the second connecting portion side concave portion 234 of the connecting portion 230. Accordingly, compared with a case where the connecting portion 230 and the terminal portion 210 are engaged with each other by threaded engagement or the like, for example, the connecting portion 230 can be strongly fixed to the terminal portion 210.

### (Other Modifications)

The method for manufacturing an energy storage device according to the present invention and the energy storage device have been described based on the embodiment heretofore. However, the present invention is not limited to the above-mentioned embodiment.

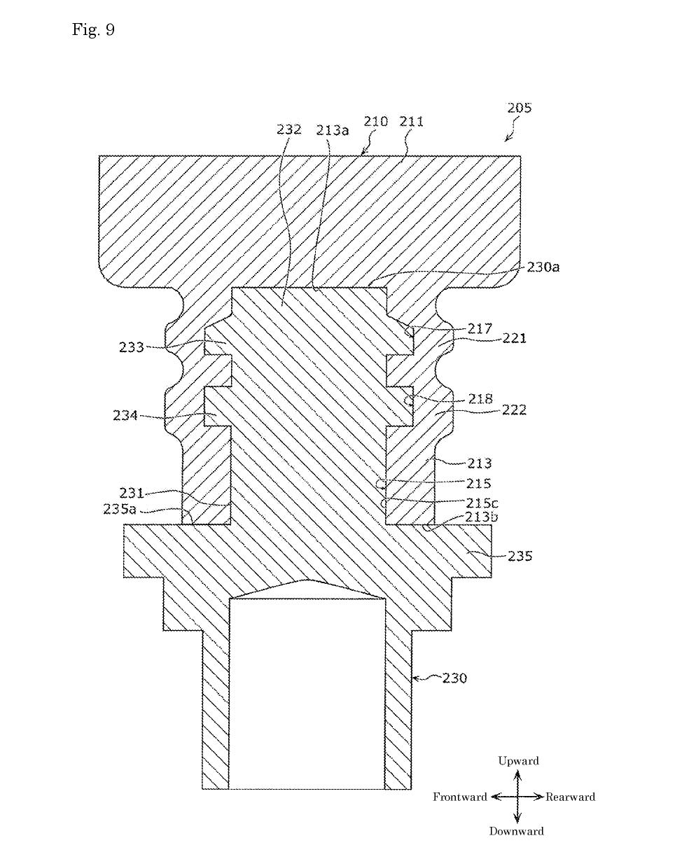

FIG. 9 is an enlarged cross-sectional view showing a negative electrode terminal of an energy storage device according to a modification of the embodiment, and shows a state before a tip of a connecting portion is swaged. The negative electrode terminal of the energy storage device according to the modification may have, as shown in FIG. 9, portions formed by inverting the concavo-convex shape of the first cylindrical portion inner surface side convex portion of the cylindrical portion, the second cylindrical portion inner surface side convex portion of the cylindrical portion, the first connecting portion side concave portion of the connecting portion, and the second connecting portion side concave portion of the connecting portion of the embodiment shown in FIG. 4. In this case, the connecting portion side concave portion becomes the connecting portion side convex portion, and the cylindrical portion inner surface side convex portion becomes the cylindrical portion inner surface side concave portion. Further, the cylindrical portion may have both the cylindrical portion inner surface side convex portion and the cylindrical portion inner surface side concave portion.

In the above-mentioned embodiment, the first connecting portion side concave portion and the second connecting portion side concave portion may not be formed annularly, and may be simply formed of a groove which is concaved from the outer peripheral surface of the shaft portion. The groove concaved from the outer peripheral surface may have any shape. The first connecting portion side concave portion and the second connecting portion side concave portion are formed on the shaft portion of the connecting portion. However, besides such a configuration, annular groove portions having substantially the same configuration as the first connecting portion side concave portion and the second connecting portion side concave portion may be formed on the shaft portion of the connecting portion, concave portions having the configuration different from the first connecting portion side concave portion and the second connecting portion side concave portion may be formed on the shaft portion of the connecting portion, or either one of the first connecting portion side concave portion or the second connecting portion side concave portion may not be formed. In these cases, the first cylindrical portion inner surface side convex portion and the second cylindrical portion inner surface side convex portion of the cylindrical portion may be formed corresponding to the concave portions formed on the outer peripheral surface of the shaft portion of the connecting portion. Further, it is preferable that the first connecting portion side concave portion and the second connecting portion side concave portion be formed in a direction intersecting with a vertical direction (inserting direction) of the shaft portion. In this case, the removal of the connecting portion from the terminal portion can be prevented. In this embodiment, such configurations also may be adopted by the modification shown in FIG. 9 where the concavo-convex shape is inverted.

The insertion hole formed in the cylindrical portion of the terminal portion and the shaft portion of the connecting portion are formed into a circular shape as viewed from an upper direction to a lower direction. However, the shapes of these portions are not limited, and may be a polygonal shape, a semicircular shape, an elliptical shape or the like. Further, the insertion hole formed in the cylindrical portion of the terminal portion and the shaft portion of the connecting portion may also be formed in a conical shape where a diameter of the insertion hole and a diameter of the shaft portion are gradually decreased toward a direction that the shaft portion is inserted into the insertion hole.

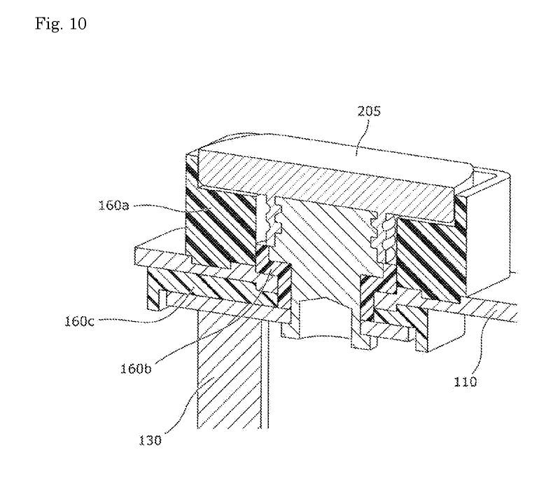

The positive electrode sealing member and the negative electrode sealing member are integrally formed with the lid body and the terminal respectively by a method such as insert molding. However, the positive electrode sealing member and the negative electrode sealing member may be formed using one or more gaskets which are respectively formed of a molded member or the like. That is, for example, as show in FIG. 10, without using insert molding, a negative electrode terminal 205 may be fixed to a lid body 110 by performing swaging using gaskets (three negative electrode sealing members 160a, 160b, and 160c in FIG. 10). FIG. 10 is a perspective view showing the cross-sectional configuration of the negative electrode terminal and portions around the negative electrode terminal of an energy storage device according to a modification of the embodiment. With such a configuration, the energy storage device can keep gastightness. The number of gaskets may not be limited to three and may be two or four or more.

In the above-mentioned various modes, the current collector and the connecting portion of the terminal are formed as separate parts. However, the current collector and the connecting portion of the terminal may be integrally formed with each other.

It is preferable that the flange portion be formed on the connecting portion. However, the flange portion may not be formed on the connecting portion, and is not an indispensable constitutional element. The flange portion is formed into a circular annular shape as viewed in a vertical direction. However, the flange portion is not limited to a circular annular shape, and the shape of the flange portion is not limited. The flange portion may be formed of a flange having a polygonal shape, an elliptical shape or the like. Further, the flange portion is not limited to an annular shape, and may be simply one or more protrusions protruding from an outer peripheral surface of the cylindrical portion. In this case, the connecting portion is minimally rotatable relative to the resin portion (sealing member) and the terminal portion.

Other configurations such as configurations acquired by applying various modifications which those who are skilled in the art conceive to the embodiment, and the configurations acquired by arbitrarily combining the constitutional elements and functions described in the embodiment without departing from the gist of the present invention are included in the scope of the present invention.

### INDUSTRIAL APPLICABILITY

The present invention is applicable to an energy storage device such as a lithium ion secondary battery or the like.

### DESCRIPTION OF REFERENCE SIGNS

10: energy storage device
100: case
110: lid body
111: case body
112: through hole
122, 132: electrode assembly connecting portion
130: negative electrode current collector (current collector)
131: current collector body portion
133: through hole
140: electrode assembly
160, 160a, 160b, 160c: negative electrode sealing member (resin portion)
200: positive electrode terminal
205: negative electrode terminal
210, 210′: terminal portion
211: body portion
213, 213′: cylindrical portion
213a: bottom surface
213b: lower end surface
215: insertion hole
217: first cylindrical portion inner surface side convex portion (cylindrical portion inner surface side convex portion)
218: second cylindrical portion inner surface side convex portion (cylindrical portion inner surface side convex portion)
221: first cylindrical portion outer surface side concave portion (cylindrical portion outer surface side concave portion)
222: second cylindrical portion outer surface side concave portion (cylindrical portion outer surface side concave portion)
230: connecting portion
230a: tip surface
231: outer peripheral surface
232: shaft portion
233: first connecting portion side concave portion (connecting portion side concave portion)
234: second connecting portion side concave portion (connecting portion side concave portion)
235: flange portion

1. An energy storage device, comprising:
a terminal portion;
a current collector; and
a connecting portion which connects the terminal portion and the current collector,
wherein the terminal portion includes a cylindrical portion which is bottomed at one end side and is open at an other end side,
wherein the connecting portion is inserted into and connected to the cylindrical portion,
wherein, on an outer surface of the connecting portion, a concave portion of the connecting portion or a convex portion of the connecting portion is formed, and
wherein, on an inner surface of the cylindrical portion, a convex portion on the inner surface of the cylindrical portion or a concave portion on the inner surface of the cylindrical portion, which is engaged with the concave portion of the connecting portion or the convex portion of the connecting portion, is formed.

2. The energy storage device according to claim 1, wherein, on an outer surface of the cylindrical portion, a concave portion on the outer surface of the cylindrical portion or a convex portion on the outer surface of the cylindrical portion, is formed at a position which corresponds to the convex portion on the inner surface of the cylindrical portion or the concave portion on the inner surface of the cylindrical portion.

3. The energy storage device according to claim 1, wherein the concave portion of the connecting portion or the convex portion of the connecting portion is formed annularly.

4. The energy storage device according to claim 1, wherein the connecting portion includes a flange portion which is in contact with at least a part of a surface at the other end side of the cylindrical portion of the terminal portion.

5. The energy storage device according to claim 4, further comprising a resin portion which is integrated with the cylindrical portion of the terminal portion and the flange portion of the connecting portion to cover the cylindrical portion and the flange portion.

6. The energy storage device according to claim 1, wherein a material of the terminal portion is aluminum or aluminum alloy, and
wherein a material of the connecting portion is copper or copper alloy.

7. A method of manufacturing an energy storage device, comprising:
an inserting in which a connecting portion, which connects a terminal portion and a current collector, is inserted into a cylindrical portion which is formed in the terminal portion and is bottomed at one end side and is open at an other end side, and
a forming in which, on an inner surface of the cylindrical portion, a convex portion on the inner surface of the cylindrical portion or a concave portion on the inner surface of the cylindrical portion, which corresponds to a concave portion of the connecting portion or a convex portion of the connecting portion on an outer surface of the connection portion, is formed by pressing the cylindrical portion from an outer surface.

8. The method of manufacturing the energy storage device according to claim 7, wherein, in the inserting, the connecting portion, on which the concave portion of the connecting portion or the convex portion of the connecting portion is formed, is inserted into the cylindrical portion, and
wherein, in the forming, the convex portion on the inner surface of the cylindrical portion or the concave portion on the inner surface of the cylindrical portion in the cylindrical portion, which corresponds to a concave portion of the connecting portion or a convex portion of the connecting portion formed on an outer surface of the connection portion, is formed by pressing the cylindrical portion from an outer surface toward the connecting portion.
